(19) United States
(12) Patent Application Publication
(10) Pub. No.: US 2003/0011795 A1
(43) Pub. Date: Jan. 16, 2003

(54) Belt control means for an image forming apparatus

(76) Inventors: Bobo Wang, Palos Verdes Estates, CA (US); Po Chih Wang, Irvine, CA (US)

Correspondence Address: Aetas Technology Inc., Suite 200, 120 Theory Drive, Irvine, CA, 92612, US

(21) Appl. No.: 09/892,425

(22) Filed: Jun. 27, 2001

(51) Int. Cl. G06F 15/00; B41J 1/00

(52) U.S. Cl. 358/1.9

(57) ABSTRACT

A belt exhibits non-uniform motion in directions transverse, diagonal, or at an angle from the belt travel path. The present invention monitors belt motion changes in the organic photoconductor belt's changes in speed and position in directions not parallel to the organic photoconductor belt's direction of travel. By comparing discrepancies between velocities in orthogonal directions, the exposure light sources for forming a latent image on the organic photoconductor belt can be shifted to accommodate non-uniform motion.

### FIELD OF THE INVENTION

The invention relates to the art of sensing the relative position and velocity of a moving organic photoconductor (OPC) belt in an image forming system. In particular, the invention relates to a tone-on-tone system and method to more accurately overlap toner particles to compensate for image misregistration. A polymer strip with fiduciary markings, secured to the OPC belt, acts with a light source to measure the exact location of the belt. Also, the fiduciary markings may be printed directly on the belt, instead of securing a polymer strip to the belt.

### BACKGROUND OF THE INVENTION

Non-impact printing involves the use of an image carrying member (e.g. OPC member) that is initially charged to a substantially uniform potential. Non-impact printing is carried out through several different processes, including ink jet, toner jet, electrophotographic imaging (“EPG”), liquid toner, direct imaging, and other non-impact printing methods. While the present application applies to any non-impact printing method, the following description will use the EPG method and system by way of an example. Any references to an EPG method or system shall be construed to apply equivalently to any non-impact printing method or system. An electrostatic latent image is formed on the surface of the OPC belt, usually by way of a light source, which discharges the charged OPC belt in selected areas. The latent image is then transferred by bringing a developer material, typically a toner, into contact with the OPC surface. The completed image is then transferred to a recording sheet (e.g. paper sheet, transparency sheet) and permanently affixed thereto by fusing with applied heat and pressure.

In multicolor printing, a plurality of images are formed and transferred onto the OPC belt. Typically, a four-color image requires a separate image for each of the four colors (e.g. cyan, magenta, yellow, and black) which are transferred onto the OPC belt and superimposed to form a single image.

An OPC belt containing a color image in an EPG imaging system basically is a grid of pixels whose size, color, and spatial relationship create an illusion of a single complete image. A pixel is a point on the latent image on the OPC surface, exposed by a light source (e.g. light emitting diode, “LED,” liquid crystal display array, “LCD,” or other fixed optical source). In this regard, each pixel represents a particular color that contributes to the visual aspects of the color image. To create the desired color, each pixel may be superimposed upon other pixels of the same or different corresponding color. Upon development, several very small colored plastic particles adhere to the corresponding pixel locations. These colored particles, known as toner particles, are fused so as to blend and adhere to the recording sheet to complete the image creation.

To achieve printing of all the colors of the rainbow in a color image, an EPG imaging system may employ four-color print stations that use toner particles having a cyan, magenta, yellow, or black color. For example, under the cyan, magenta, yellow, or black (CMYK) subtractive color system, magenta and yellow make red, cyan and magenta make blue, and cyan and yellow make green.

To make a green dot, for example, a cyan toner particle may be transferred from a first print station onto a pixel on an electrostatically charged OPC belt. The OPC belt then may be rotated so as to position the cyan toner particle underneath the second print station having yellow toner particles. A yellow toner particle may then be transferred from the second print station onto, or near, the cyan toner particle. Stacking of one toner particle on top of another toner particle may be referred to as a “tone-on-tone” or an “image-on-image” process. Depending on the imaging needs, a toner particle may be stacked entirely on top of a previously transferred toner particle, or the toner particle may lie on top of only a portion of the previously transferred toner particle. The stack then may be transferred to a recording sheet where the stack is fused to form a green dot.

One of the difficulties encountered in transferring a multi-color image to an OPC belt is image misregistration. Image misregistration is where the image pixels are misaligned on the OPC belt surface. As the misalignment increases, the variation of stacking one toner particle on top of another increases so as to give a poor image quality. To improve image quality and minimize image misregistration, it is desirable to increase the accuracy with which a tone-on-tone EPG development system stacks toner particles.

In multipass color printing, one color is imaged and transferred to the OPC belt, where it rotates one full cycle before the next color is imaged and transferred. Thus, the OPC belt makes multiple passes before transferring a given multi-color image to a recording sheet.

In single pass color printing, the individual colors are superimposed on the OPC belt before being transferred to the recording sheet. The OPC belt thus makes only a single pass to acquire and retain the latent images for each of the color separations and then transfers a multicolor image to a recording sheet in a single operation.

Imaging devices require that the image transferred to the OPC be registered accurately with the image light source. Both single and multipass color printing require precise control of the OPC belt and its interaction with the imaging, developing, and transfer stations of the printing apparatus for the correct registration between the color images and to avoid any image degradation. Tone-on-tone imaging devices require accurate registration to correctly superimpose color images. The OPC belt's motion must be accurately controlled, especially in the span of the belt that encompasses the imaging and developing stations. The average toner particle diameter is between about 8 to about 15 micrometers. The positional accuracy required for acceptable registration in the trade is typically below a maximum limit of 125 micrometers. Some imaging techniques require registration inaccuracy of no more than about 30 micrometers between color images for pictorial information.

Various devices and systems for controlling and synchronizing OPC belt motion are known. For example, one approach, in U.S. Pat. No. 4,445,128, is to use an encoding roller to track the motion of the OPC belt. The encoder provides data on belt motion registration to a servomechanism that controls the belt drive roller. The encoder can also provide motion data to the light sources (e.g. print heads) that produce the latent images on the belt.

Also, a rotary encoder roller can be part of a color registration system to provide a clocking signal for controlling color registration, as disclosed in U.S. Pat. Nos. 5,200,782 and 5,200,791. Another variation, disclosed in U.S. Pat. No. 5,153,644, entails an encoder wheel on the OPC belt. The wheel sits above the belt, at one edge of the belt. A backing roller supports the belt from the underside of the belt.

As depicted in FIG. 2, encoder rollers usually include a long roller 52 that extends across and engages the span of the OPC belt 12. The roller's shaft connects to an encoding device that produces an electronic encoder signal corresponding to the roller rotation and belt speed. To accurately control the belt speed, the roller eccentricity and composite roller runout must be kept within very strict tolerances. Eccentricity is the variation between the rotational center and the geometric center of the roller. Composite roller runout is the overall variation in eccentricity across the roller's length. The roller speed control system is a closed loop system to maintain a constant encoder roller angular velocity. Thus, the roller eccentricity and composite roller runout result in small variations, or modulations, in the OPC belt's linear velocity. This contributes to registration errors.

Some EPG printing devices use an encoder roller that operates synchronously with the OPC belt. The belt's length is chosen as an integer multiple of the encoder roller circumference so that the encoder roller is in the same phase orientation with every rotation of the OPC belt. In these devices, the composite roller runout must be controlled carefully. If the composite roller runout is not controlled carefully, then synchronous operation and color registration within acceptable limits is not feasible. Acceptable composite runout tolerances usually are within +/−0.05 mm. On a long roller, such tolerances become difficult to maintain and result in increased manufacturing costs. Thus, an encoder roller with acceptable accuracy cannot be produced at a low cost.

In such printing devices, especially multipass architectures that use a synchronous encoder roller and OPC belt, the two greatest contributors to misregistration are the roller diameter and eccentricity. One solution is to increase roller diameter. However, space limitations prevent the use of large diameter encoder rollers or wheels. Furthermore, the rotary encoder is not effective for characterizing belt slippage. One example of a non-uniform belt motion is when the belt momentarily shifts position in a direction substantially perpendicular to the normal belt path. Another example is when the belt momentarily disengages from a roller surface in a direction substantially parallel with the normal belt path. Also, a belt's flexibility increases the likelihood of non-uniform motion (e.g. belt vibration, waves, flutter, non-steady-state motion). A rotary encoder mounted on a belt roller cannot adequately communicate such non-uniform motion in a belt. Thus, a device that travels with the belt, instead of the roller, would be more effective in determining the exact location and velocity of the belt.

Encoder strips or “code strips” are used in image-related devices such as printer/plotters, scanners, facsimile machines and the like. Imaging devices require that the image transferred onto the OPC be registered accurately with the image light source. A code strip helps establish the position of a marking or sensing device mounted for exposing across a printing medium on which an image is to be printed, or from which an image is to be read.

A code strip is a graduated strip, generally disposed across an area where the medium is held, and having gradations that can be automatically sensed. Historically code strips have been made of polymer material with fiduciary markings formed photographically. For optimum performance, the code strip's fiduciary markings should be very close to both a light source and a detector used as parts of a sensing system for reading the fiduciary markings.

Using a code strip obviates the need for an encoder wheel or roller, as the strip rides along with the OPC belt in concert with the belt's motion. Instead of using a large diameter roller, a thin strip attached or printed to the belt surface occupies negligible space in the printer architecture. Without an encoder roller, the two greatest contributions to misregistration, roller runout and eccentricity, disappear. The space saved can be used by other hardware. Color systems require substantial hardware space for multiple development stations, erase stations, charging stations, and light sources. Multiple pass systems require the OPC belt to revolve several times. Each cycle can multiply the effects from roller tolerances. Using a code strip that moves with the belt provides more accurate data about the belt motion.

Another attempt at monitoring OPC belt motion is disclosed in U.S. Pat. No. 4,837,636, where an EPG device uses an OPC belt containing one row of discrete translucent marks along one side, a light source opposite the marks, and a light detector situated to provide blocks of image signals representing the instantaneous pattern of marks. A circuit is described for converting the image signal output of the clock signals representative of the OPC belt speed and position.

While this arrangement may provide a space savings over the encoder roller arrangement, the use of only one row of marks alongside the belt margin does not adequately monitor transverse belt motion. The single row of marks in the margin may adequately describe a belt's motion in the direction of belt travel. However, a belt also exhibits non-uniform motion in directions transverse, diagonal, or at an angle from the belt travel path. Thus, a need exists for a belt motion monitoring arrangement that monitors changes in the OPC belt's changes in speed and position in directions not parallel to the OPC belt's direction of travel.

### SUMMARY OF THE INVENTION

The present invention relates to the art of encoding the movement of an OPC belt. More particularly, the present invention contains markings in at least two directions (“bi-directional”). Once the code strip is disposed on an OPC belt and used in an EPG printing device, a light source and a light detector can accurately detect the location and velocity of the code strip in space spanned by at least two orthogonal directions.

A belt exhibits non-uniform motion in directions transverse, diagonal, or at an angle from the belt travel path. The present invention monitors belt motion changes in the OPC belt's changes in speed and position in directions not parallel to the OPC belt's direction of travel. By comparing discrepancies between velocities in orthogonal directions, the exposure light sources for forming a latent image on the OPC belt can be shifted to accommodate non-uniform motion.

Still, other advantages and benefits of the invention will become apparent to those skilled in the art upon a reading and understanding of the following detailed description.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views. The invention may take physical form in certain parts and arrangements of parts a preferred embodiment of which will be described in detail in this specification and illustrated in the accompanying drawings, which form a part hereof, wherein:

FIG. 1 is a schematic diagram illustrating an electrophotographic printing apparatus according to the present invention.

FIG. 1A is an illustration of a sensor and detector module as seen along line 1A-1A in FIG. 1.

FIG. 2 is an illustration of an encoder according to the prior art.

FIG. 3A is an illustration of a preferred embodiment of the code strip.

FIG. 3B is an illustration of an alternative embodiment of the code strip.

FIG. 3C is an illustration of an alternative embodiment of the code strip.

FIG. 3D is an illustration of an alternative embodiment of the code strip.

FIG. 4 is an illustration of an OPC belt containing a code strip, but not containing code strip material around joint area.

FIG. 5 is a graphic representation of pixel location without compensation for non-uniform motion according to this invention.

FIG. 6 is a graphic representation of pixel location with compensation for nonuniform motion according to this invention.

FIG. 7 is an illustration of an LED array.

FIG. 8 is an illustration of the preferred method of monitoring belt motion.

FIG. 9 is an illustration of an OPC belt with code strip according to the preferred embodiment of the present invention.

### DETAILED DESCRIPTION OF THE PREFERRED EMBODIMENT

Referring now to the drawings wherein the showings are for the purposes of illustrating the preferred embodiment of the invention only and not for purposes of limiting the same, the figures show an EPG printing apparatus having a code strip according to the present invention.

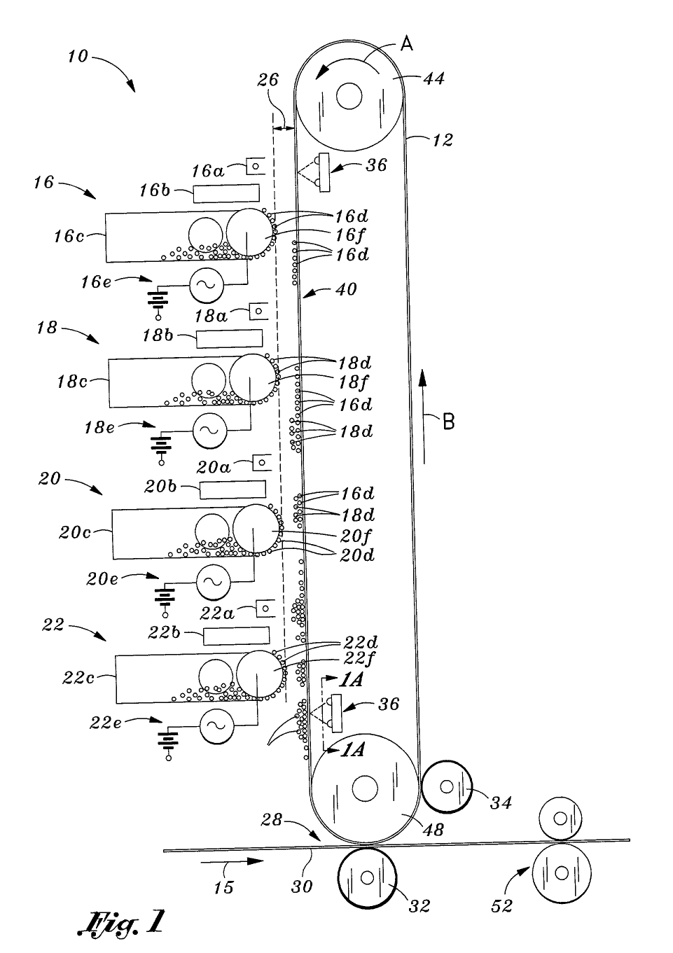

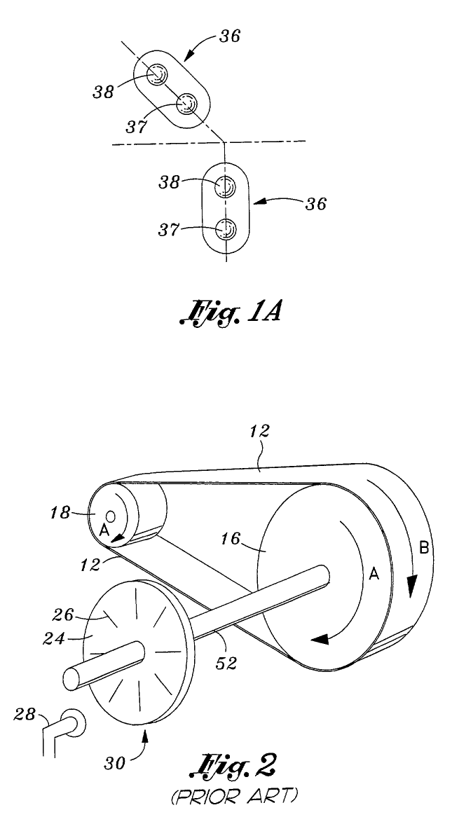

Referring to FIG. 1, an EPG printing apparatus 10, suitable for practicing the present invention is illustrated. This particular arrangement illustrated is a discharge area development (DAD) printing technique. It will be recognized that the advantages of the present invention will apply to other EPG techniques, and any other apparatus that incorporates a moving belt.

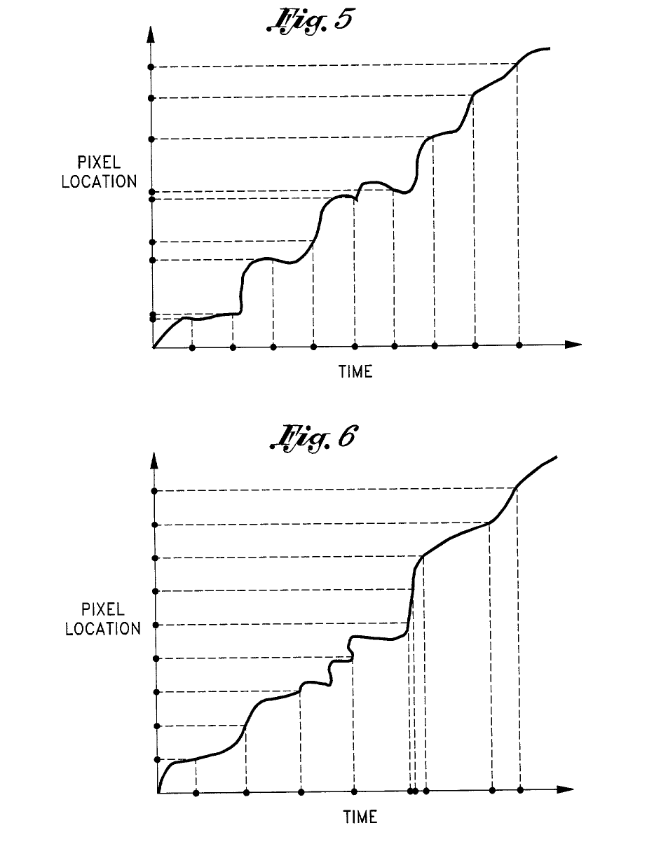

OPC belt 12 is entrained around an idle roller 44 and a drive roller 48, which is coupled to a motor (not shown). The outside surface of belt 12 contains a charge retentive material. As seen in FIG. 4, the belt 12 may include a seam 304 and a code strip 306. The seam 304 may result from splicing together the opposing ends of the belt 12 to form a looped configuration joined by the seam 304. The seam 304 defines a location known as the home position. The code strip 306 may be coupled to the belt 12. The code strip 306 may include an end 408 and an end 410 so that the seam 304 is disposed between the end 408 and the end 410. As shown in FIG. 1, belt 12 travels in direction of arrow B, the process direction, and first encounters a corona charge device 16a, where the charge retentive surface is charged to a uniform potential. The belt surface is then exposed to a latent image at imaging station 16b, which is a light source that may include a light emitting diode (LED) array 222, shown in FIG. 7. The latent image is formed as the LED array scans across the moving belt 12 to expose and discharge selected areas of belt 12. In a typical EPG process, the discharged areas correspond to text or imaged areas on the original document.

The latent image is transferred as the selectively discharged areas of the belt 12 move past developing device 16c, which typically provides black toner to the discharged areas. The belt then moves past a second charge device 18a and a second light source 18b to provide a second latent image on belt 12. The second latent image is superimposed onto the black image previously transferred onto the belt and toner is transferred from developing device 18c with a first color toner, e.g. yellow. In a similar manner, third and fourth charge and development stations provide respective latent images in two other colors, usually magenta, and cyan, respectively. Belt 12 is thus provided with a multi-color image. The multi-color image is transferred to a recording sheet 30, e.g., a blank sheet of paper, which is conveyed in contact with belt 12 in the direction of arrow 15 at transfer station 28. A fuser assembly 52 applies heat to fuse the toner particles onto the recording sheet.

The code strip is attached or printed to the OPC belt surface. As shown in FIG. 1A, a light source 37 illumines the fiduciary markings. A light detector 38, adjacent to the code strip and in a position to detect light reflected from the code strip, detects the individual light signals corresponding to the movement of belt 12. The light detector 38 produces an electric signal that is conveyed to a controller (not shown), which determines the precise time to actuate the individual light sources 223 to selectively discharge areas of the OPC belt 12. Control signals are provided to light source 222 and to second, third, and fourth charge, development, and erase stations.

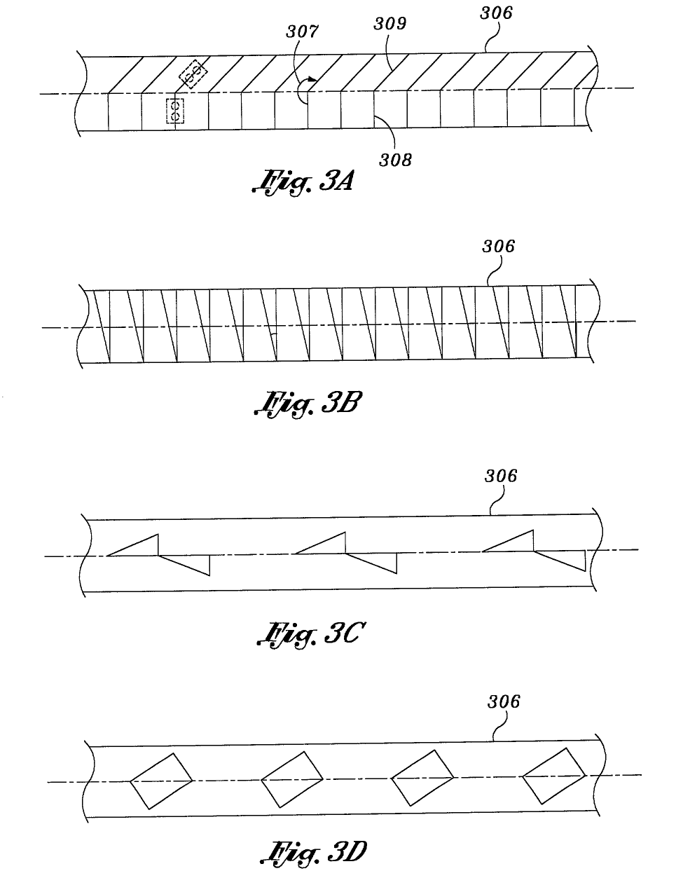

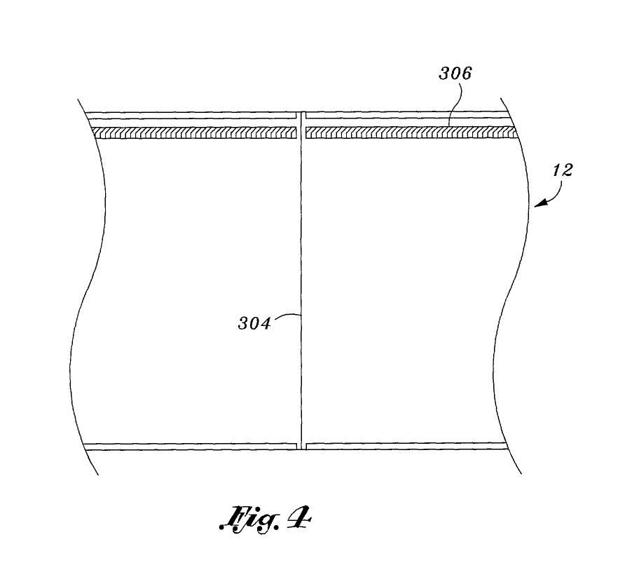

FIG. 3A shows a code strip and OPC belt configuration according to a preferred embodiment of the invention. A code strip of the type attached to the belt surface can be composed of several layers. One configuration may include, top to bottom, a structural base, film emulsion, reflective mylar, and optical adhesive. In FIG. 1, an electrophotographic printing device 10 incorporating non-uniform motion compensation according to this invention is shown in schematic form. The electrophotographic printer adapted to employ the present invention therein comprises an OPC belt 12. The belt is mounted on a rotatable drive roll 16 and idler roll 18, which rotate in direction A as shown by the arcuate directional arrow. Photoconductive surface 14 is moved continuously in direction B at various speeds ranging from approximately 50 millimeters per second to approximately 100 millimeters per second. Motive power for the rotation of the belt can be by any suitable electrical or electromechanical drive mechanism, not shown.

A motion encoder 20 is used to monitor the motion of the OPC belt 12 and to produce a digital timing signal indicative of the OPC belt motion. It will be understood that the motion encoder 20 can be any suitable device for sensing the motion of the OPC belt 12 from the fiduciary markings and generating a digital signal representative of the motion including, for example, photo-detecting, magnetic or capacitive devices for sensing the displacement of the OPC belt 12. The motion encoder 20 may detect the light pulses from the code strip to track the movement of the OPC belt 12 and generate a digital signal corresponding thereto which is fed through logic circuit 32 to the LED drive circuit 34. As will be explained more fully, the output of the motion encoder 20 is combined with the timing signals used in the LED drive circuit to selectively actuate individual groups of LEDs contained in the diode array and selectively discharge localized areas of the OPC surface as shown in FIG. 1.

A code strip 306 is attached or printed onto one side or margin of OPC belt 12 outside of the area used for imaging. Discrete marks 308, 309 on code strip 306 preferably extend around the circumference of OPC belt 12. FIG. 3A is a detailed view of the code strip 306 of FIG. 3. The code strip 306 may include material to define a pattern having an X component and a Y component. In one embodiment, the defined patterned has a plurality of marks, where each mark includes a first segment 308 and a second segment 309 disposed at an obtuse angle 307 to the first segment. In another embodiment, the defined pattern includes 4,000 marks over the standard 11.0-inch length of a page of paper, the marks spaced 2.75×10⁻³ inches (=7.0 gm) apart. Since each toner particle may have about a 12- to 15-micrometer (μm) diameter, placing a mark every 7.0 μm means that each toner particle may overlap two marks. Sensors 36 are suitably mounted on machine 10 in predetermined spaced relation opposite the margin 84 of OPC belt 12 and in line with the path of travel of the code strip 306 in OPC belt 12. The longitudinal axis of the row of photodiodes 86 is substantially parallel with the axis of movement of the code strip 306. Preferably, the optical axis of photodiodes 86 is aligned with the center of the discrete marks 308, 309.

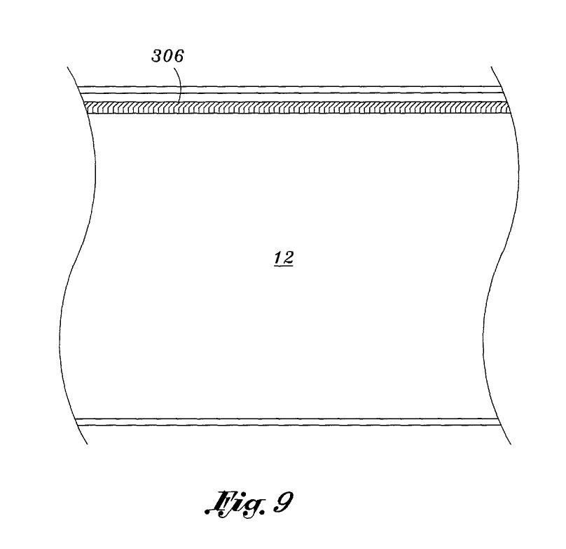

In FIG. 8, code strip 306 is magnified to illustrate the preferred method of monitoring belt motion. The code strip travels in the same direction as the belt, indicated by arrow C. If the belt travels uniformly, the light detector detects a sequence of regular periodic signals corresponding to the reflections between the fiduciary marks. If the belt motion is not uniform (e.g. belt slips over roller surface, belt hesitates, belt walks, belt wobbles), then the signals detected are not separated by equal time periods.

The marks on side A of the code strip are perpendicular to the direction C. The process direction, C, is described by the component y, while the direction orthogonal to the process direction is described by the component x. The marks on side B of the code strip are situated differently with respect to direction C. The angle between direction C and the side B marks is between about 0 degrees and about 180 degrees. Preferably, the angle should be 135 degrees, as any motion in the x-direction is composed of orthogonal components of equal magnitude.

Assuming steady state before time t=0, light sources and sensors are located at locations A′ and B′ at time t=0. As the code strip and OPC belt proceed in direction C, the respective light sources illuminate sections of the code strip as the marks pass under the respective light source. Light from the light source reflects from in between each mark. The reflected light is detected at the respective light detector. As each light signal registers, the number of marks is counted. The number of marks represents belt movement, which can be used to determine belt velocity with the respective elapsed time.

At time t=t′, the location on the code strip formerly at A′ is currently at A″. Likewise, the portion of the code strip previously at B′ is currently at B″. The distance between A′ and A″ is equal to the distance between B′ and B″, representative of the elapsed time, t′. While the distance traversed by the belt in the y-direction can be easily determined by the number of marks in the A section of the code strip, this information cannot be used to determine the distance traversed by the belt's non-uniform motion in the x-direction.

The B portion of the code strip contains slanted marks that can be used to determine the non-uniform belt motion. If the belt's motion is uniform, then the sensor in Region B would detect each slanted mark in region B with the same time incremental period as detected in Region A, where the marks are perpendicular to direction C. However, when the belt's motion is non-uniform, the elapsed time between each mark in region B is not equal. In the example displayed in FIG. 8, 32 marks pass under the region B light and sensor, while the corresponding number of marks in Region A during the belt's travel from B′ to B″ is only 15.

By comparing the distance, represented by the number of marks detected from A′ to A″, with the number of marks detected from B′ to B″, the amount of x-motion can be determined. The number of marks from B′ to B″ that exceed the number of marks from A′ to A″ represent the amount of non-uniform motion, namely the x-motion.

An elongated light bar 222 is suitably mounted in machine 10 on the side of OPC belt 12 in predetermined spaced relation with OPC belt 12. The operating length of light bar 222 is at least sufficient to provide substantially equal illumination to each of the photodiodes 223, with the longitudinal axis of bar 222 being substantially parallel with the longitudinal axis of the array.

While discrete markings 308, 309 are illustrated and described herein, transparent or translucent fiducial marks, alternating with opaque or translucent marks, may be envisioned. The fiducial marks 308, 309 in OPC belt 12 do not require precise placement, cutting, etching, or application. Instead, the accuracy of resolution is determined by the placement of photodiodes 223 on array 222, which is extremely precise. However, it is necessary that the number and disposition of the fiducial marks 308, 309 and the length of the array of photodiodes 223 of array 222 be such that the maximum spacing between any two adjacent discrete markings 308, 309 is less than the length of the array of photodiodes 223.

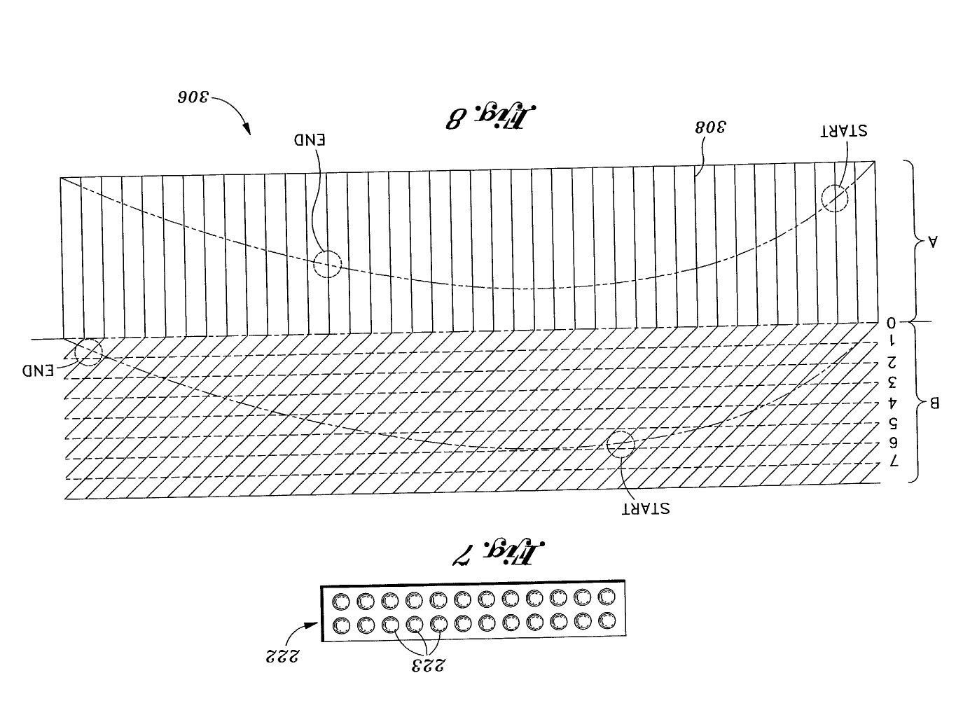

In FIGS. 5 and 6, the curve 90 represents the speed of the OPC belt 12. In FIG. 5 there is graphically represented the dot printing intervals on the pixel location axis without non-uniform motion compensation according to this invention. As the LED array 222 is energized at regular intervals of time 92 on the time axis, the pixels 98 are placed on the OPC belt 12 at regular intervals as a result of non-uniform OPC motion thus degrading image quality. In FIG. 6, the pixel intervals 96 are represented graphically on the pixel location axis. When the timing of the actuation of diodes 223 in the array 222 is varied in response to a change in velocity or non-uniform motion by the OPC belt as shown at selected points 94 on the time axis, the pixels 96 are located at regular evenly spaced intervals, as shown on the pixel location axis, thus ensuring a high quality image despite the OPC belt 12 motion being irregular or uneven.

The invention is not limited to addressing the above problem. Another problem in using photoreceptor belts is imaging at the seam or splice 304. Since the seam 304 comprises an overlap of OPC material, it is undesirable for a tone-on-tone electrophotographic apparatus to perform imaging at the seam 304. Likewise, a spliced area contains incongruities that cannot properly retain a charged image. Thus, it is desirable for the imaging system 10 to know the location of the seam when imaging.

Conventionally, a hole or notch is cut into an OPC belt as a technique to locate the seam. However, such notches eventually collect toner and redistribute the same, potentially contaminating the other components within the apparatus. The present invention works to minimize the mess caused by this collected toner by eliminating the need to cut a hole or notch into the belt 208.

In one embodiment, the invention reads the code strip 306 to know where the end 308 and the end 310 reside, between which is the home position of the seam 304. In another embodiment, the seam or splice 304 could be detected by using the fiduciary marks located on the code strip 306. The code strip 306 may include a defined number of fiduciary marks within the code strip 306 (e.g., n marks per inch of code strip 306). Based on the defined number of fiduciary marks within the code strip 306, the control device 316 may determine the position of the seam 304 as a certain distance x from a fiduciary mark. In one embodiment, mark #238 of 4,000 total marks within the code strip 306 represents the fiduciary mark from which the distance x to the seam 304 is measured.

Another problem in using photoreceptor belts is that individual lighting elements of the LED print heads (LPH) 222, 232, 242, and 254 may become misaligned so as to result in image misregistration. This problem is detailed in U.S. patent application Ser. No. 09/718,069. U.S. patent application Ser. No. 09/718,069 is assigned to the assignee of this patent. The contents of U.S. patent application Ser. No. 09/718,069 are incorporated herein.

After receiving a signal of belt misregistration, the control device 316 may work to direct LPHs 222, 232, 242, and 254 through software or firmware to compensate for the misregistration. The compensation may include an misregistration signal to engage different lighting elements in sequences as a function of the misregistration signal during the same, overall timing than what would normally occur without an image misregistration.

The invention has been described with reference to the preferred embodiments. Obviously, modifications and alterations will occur to others upon a reading and understanding of the specification. For example, the concept of the present invention is also applicable to printing techniques involving more than four-color printing and to the retrofit of existing apparatus. It is intended to include all such modifications and alterations so far as they come within the scope of the appended claims or the equivalents thereof.

We claim:

1. An imaging system to create a toner particle stack that compensates for image misregistration, the imaging system comprising:
at least two printing stations;
at least one sensor;
a belt comprising a code strip, wherein the code strip is disposed adjacent to the at least one sensor.

2. The imaging system of claim 1, wherein the code strip includes a plurality of fiduciary marks.

3. The imaging system of claim 2, wherein the plurality of fiduciary marks are arranged to convey a bi-directional pattern.

4. The imaging system of claim 2 or 3, wherein each fiduciary mark comprises a first segment and a second segment disposed at an obtuse angle to the first segment.

5. The imaging system of claim 1, wherein the code strip is an image printed upon the belt.

6. A method to compensate for image misregistration of a toner particle stack in an imaging system, the method comprising:
sensing a code strip on a belt with at least one sensor to produce a first position signal; and
transferring a first toner particle onto the belt from at least one print station as a function of the first position signal; and
sensing the code strip on the belt with the at least one sensor to produce a second position signal; and
transferring a second toner particle onto the first toner particle from the at least one print station as a function of the second position signal.

7. The method of claim 6, wherein the at least two print stations are a first print station comprising the first toner particle and a second print station comprising the second toner particle.

8. The method of claim 6, prior to sensing a code strip, preparing the code strip by arranging a plurality of fiduciary marks to convey a bi-directional pattern.

9. In a non-impact printer having a moving organic photoreceptor, fiduciary marks on the moving photoreceptor surface, an image information data signal source and a light emitting diode array operatively connected to the data signal source for selective energization of individual groups of diodes within the diode array in a cycle in response to the data signal received from the source, such cycle including a predetermined interval of diode actuation followed by an interval of diode non-actuation, the diode array being located in optical registration with the photoreceptor, the method of compensating for non-uniform photoreceptor motion comprising the steps of:
monitoring the motion of the photoreceptor to generate a timing signal representative of the photoreceptor motion;
and delaying input of the data signal to the diode array in response to variations in the timing signal by varying the duration of the interval of diode non-actuation while maintaining the predetermined interval of diode energization;
whereby actuation of individual groups of the diode array is synchronized with motion of the photoreceptor.

10. An image forming apparatus having a movable organic photoconductor member, the combination of:
(a) a series of discrete fiduciary marks arranged in at least one row about the circumference of the photoconductor member, the row of marks extending in a direction parallel to the direction of movement of the photoconductor member;
(b) at least one image sensor, positioned so that the at least one sensor views a portion of the photoconductor member including at least two of the marks;
(c) means for operating the at least one sensor to repeatedly scan the photoconductor member portion and the marks currently viewed by the at least one sensor whereby to output on each scan a block of image signals representing the image presented by the photoconductor member portion with the marks, the image changing as the photoconductor member with the row of marks moves past the at least one sensor; and
(d) means for converting the blocks of image signals into a clock signal representative of the velocity of the photoconductor member.

11. The apparatus of claim 10 in which the clock signal is representative of the position and velocity of the photoconductor member.

12. The apparatus of claim 10 or 11 in which the movable photoconductor member comprises an endless photoreceptor belt.

13. An image forming apparatus having a movable organic photoconductor member, the combination of:
(a) a series of discrete fiducial marks arranged in at least one row about the circumference of the recording member, the row of marks extending in a direction parallel to the direction of movement of the organic photoconductor member;
(b) a stationary array having at least one row of image sensors, the longitudinal axis of the array being parallel to the direction of movement of the photoconductor member with the array positioned so that the row of sensors view a portion of the photoconductor member including at least two of the marks;
(c) means for operating the array to repeatedly scan the photoconductor member portion and the marks currently viewed by the row of sensors whereby to output on each scan a block of image signals representing the image presented by the photoconductor member portion with the marks, the image changing as the photoconductor member with the row of marks moves past the array; and
(d) means for converting the image signals into position control signals representing the instantaneous position of the photoconductor member.

14. The apparatus of claim 13 in which the movable photoconductor member comprises an endless photoreceptor belt.

15. A method of compensating for image misregistration of a pixel produced by a light source onto an image carrying member surface in an imaging system, the pixel having an uncompensated pixel position that is out of alignment with an ideal pixel position, the method comprising:
sensing fiduciary markings on a code strip;
the code strip affixed onto the image carrying member;
the markings measured in at least two orthogonal directions;
with at least one sensor;
determining the image misregistration as a distance between the ideal pixel position and the uncompensated pixel position; and
matching the uncompensated pixel position to the ideal pixel position.

16. The method of claim 15, wherein the matching step comprises:
delaying a formation of the pixel on the substrate by an amount of time corresponding to the image misregistration.

17. The method of claim 16, wherein the matching step further comprises:
determining a time factor based on the image misregistration.

18. The method of claim 16, wherein the step of determining a time factor further comprises:
determining a time factor that is proportional to a magnitude of the distance of the image misregistration.

19. The method of claim 15, wherein the determining step further comprises:
determining a magnitude of the distance of the image misregistration.

20. The method of claim 19, wherein the matching step further comprises:
determining a time factor that is proportional to the magnitude of the distance of the image misregistration.

21. The method of claim 20, wherein the matching step further comprises:
actuating the light source at a time modified by the time factor.

22. The method of claim 19, wherein the determining step further comprises:
determining a direction of the image misregistration.

23. The method of claim 22, wherein the matching step further comprises:
determining a time factor that is proportional to the magnitude of the distance of the image misregistration and that has a sign indicative of the direction of the image misregistration.

24. The method of claim 23, wherein the matching step further comprises:
actuating the light source at a time modified by the time factor.

25. The method of claim 15, wherein the imaging system includes an array of light sources each producing a pixel having an uncompensated pixel position that is out of alignment with an ideal pixel position; the determining step comprising:
determining the image misregistration as a distance between the ideal pixel position and the uncompensated pixel position for each light source; and
the matching step comprising matching the uncompensated pixel position to the ideal pixel position for each light source.
